(19) United States
(12) Patent Application Publication
(10) Pub. No.: US 2005/0194351 A1
(43) Pub. Date: Sep. 8, 2005

(54) Method for fabricating a light guide plate

(75) Inventors: Tai-Cherng Yu, Tu-Cheng (TW); Charles Leu, Fremont, CA (US); Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/025,885

(22) Filed: Dec. 29, 2004

(30) Foreign Application Priority Data
Feb. 20, 2004 (TW) 93104232

(51) Int. Cl. B29D 11/00; B44C 1/22

(52) U.S. Cl. 216/24; 216/41; 216/31

(57) ABSTRACT

A method for fabricating a light guide plate (80) includes: providing a first substrate (30), and coating a photo-resist layer (600) thereon; exposing and developing the photo-resist layer to form a photo-resist pattern (640); etching the first substrate; removing the photo-resist pattern; coating a metal film (520) on the first substrate; electroforming a metal layer (540) on the metal film; removing the first substrate to thereby obtain a molding core (500); providing a second substrate (70), and hot-pressing the second substrate in a hot-press die (40) using the molding core; and removing the second substrate to thereby obtain the light guide plate. The second substrate is heated until it is plastic, so that it can be easily pressed to form a predetermined shape. During the whole process, the second substrate is never in liquid form, so that the “reflux” problem of the prior art is effectively eliminated.

### BACKGROUND OF THE INVENTION

1. Field of the Invention

The present invention relates to methods for fabricating light guide plates typically used in devices such as liquid crystal displays (LCDs), and particularly to a method including a hot-pressing step.

2. Description of the Prior Art

A liquid crystal display is capable of displaying a clear and sharp image through millions of pixels of image elements. It has thus been applied to various electronic equipment in which messages or pictures need to be displayed, such as mobile phones and notebook computers. However, liquid crystals in the liquid crystal display do not themselves emit light. Rather, the liquid crystals have to be lit up by a light source so as to clearly and sharply display text and images. The light source may be ambient light, or a backlight system attached to the liquid crystal display.

A conventional backlight system generally comprises a plurality of components, such as a light source, a reflective plate, a light guide plate, a diffusion plate and a prism layer. Among these components, it is generally believed that the light guide plate is the most crucial component in determining the performance of the backlight system. The light guide plate serves as an instrument for receiving light beams from the light source, and for evenly distributing the light beams over an entire output surface of the light guide plate through reflection and diffusion. In order to keep light evenly distributed over an entire surface of the associated liquid crystal display, the diffusion plate is generally arranged on the top of the output surface of the light guide plate.

Conventionally, there are two important methods for fabricating a light guide plate: the printing method and the non-printing method. In a typical printing process, marks are coated on a bottom surface of a transparent plate, so as to form an array of dots that can scatter and reflect incident light beams. The dots can totally eliminate internal reflection of the light beams, and make the light beams evenly emit from a light emitting surface of the transparent plate. However, the precision of the printing process is difficult to control, and printing processes are gradually being replaced by non-printing processes.

Taiwan Patent Publication No. 537,955 discloses a method for fabricating a light guide plate. Referring to FIG. 11, the method includes the following steps: (a) providing a substrate, the substrate generally being made of silicon (step 101); (b) coating a photo-resist layer on the substrate (step 102); (c) exposing and developing the photo-resist layer, and wet etching V-cut patterns on the substrate, wherein an inclination of the V-cut patterns is 70.52° (step 103); (d) removing the photo-resist layer (step 104); (e) coating a conductive metal layer on the substrate (step 105); (f) performing an electroforming step, and removing the substrate to thereby obtain an electroformed molding core (step 106); (g) using the electroformed mold as an injection molding core (step 107); and (h) injection molding molten material using the injection molding core and a injection molding machine to thereby form the light guide plate (step 108).

The above-mentioned injection molding step 108 includes the following steps: heating a base material until it is molten, injecting the molten material into a cavity of the injection molding core, cooling the injection molding core and the injected molten material, and removing the injection molding core with the solidified molten material to thereby obtain the light guide plate.

However, during the injecting step, the molten material is prone to reflux toward a heater of the forming machine along a spiral chute. Because of this “reflux” problem, it is difficult to properly form the light guide plate.

It is desired to provide an improved method for fabricating a light guide plate that overcomes the above-described problems.

SUMMARY OF THE INVENTION

Accordingly, an object of the present invention is to provide a new method for fabricating a light guide plate, the method including a hot-pressing step.

In order to achieve the above-mentioned objective, a method for fabricating a light guide plate comprises the following steps: providing a first substrate having a photo-resist layer coated thereon; exposing and developing the photo-resist layer using a photo-mask to form a photo-resist pattern on the first substrate; etching the first substrate; removing the photo-resist pattern; coating a metal film on the first substrate; electroforming a metal layer on the metal film; removing the first substrate to thereby obtain a molding core; providing a second substrate, and hot-pressing the second substrate in a hot-press die using the molding core; and removing the second substrate to thereby obtain the light guide plate.

The main advantage of the present invention is as follows. The second substrate is heated until it is plastic, so that it can be easily pressed to form a predetermined shape. During the whole process, the second substrate is never in liquid form, so that the “reflux” problem of the prior art is effectively eliminated. In summary, it is easy to properly form the light guide plate using the hot-pressing method of the present invention.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is a flow chart of the method of the present invention;

FIG. 2 is a schematic, side cross-sectional view of a first substrate having a photo-resist layer coated thereon, according to the method of the present invention;

FIG. 3 is similar to FIG. 2, but showing the first substrate after exposure and developing have been completed, whereby a photo-resist pattern is defined on the first substrate;

FIG. 4 is similar to FIG. 3, but showing the first substrate after etching thereof has been completed;

FIG. 5 is similar to FIG. 4, but showing the first substrate after the photo-resist pattern has been removed;

FIG. 6 is similar to FIG. 5, but showing a metal film coated on the first substrate;

FIG. 7 is similar to FIG. 6, but showing the first substrate after a metal layer has been electroformed on the metal film;

FIG. 8 is similar to FIG. 7, but showing only the metal layer and the metal film, which together constitute a molding core;

FIG. 9 is a schematic, side cross-sectional view of the molding core of FIG. 8 and a second substrate disposed in a hot-press, with the molding core opposite to the second substrate;

FIG. 10 is a side view of a duly formed light guide plate after it has been cooled and taken out from the hot-press die of FIG. 9; and

FIG. 11 is a flow chart of a conventional method for fabricating a light guide plate.

### DETAILED DESCRIPTION OF THE INVENTION

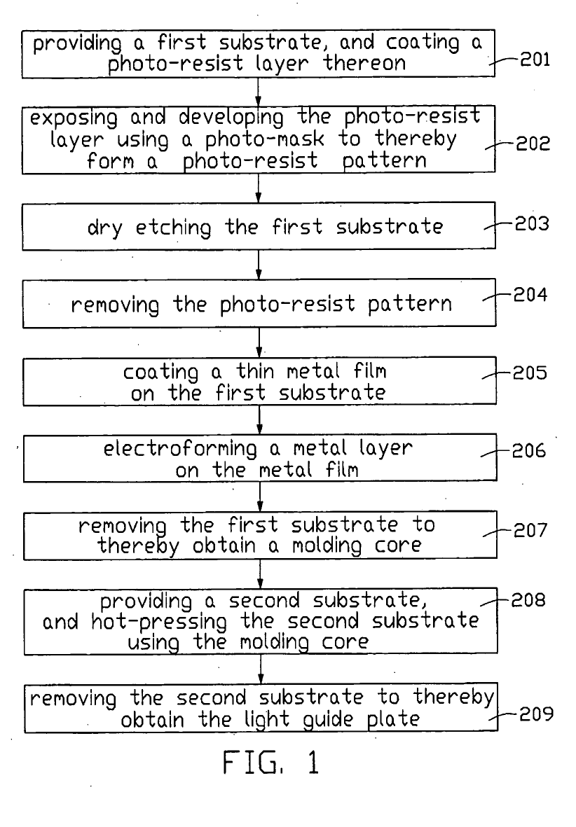

Referring to FIG. 1, a method for fabricating a plate-like light guide member in accordance with the present invention includes the following steps: (a) providing a first substrate, and coating a photo-resist layer on the first substrate (step 201); (b) exposing and developing the photo-resist layer using a photo-mask having a predetermined pattern, thereby forming a photo-resist pattern on the first substrate (step 202); (c) dry etching the first substrate (step 203); (d) removing the photo-resist pattern (step 204); (e) coating a thin metal film on the first substrate (step 205); (f) electroforming a metal layer having a certain thickness on the metal film (step 206); (g) removing the first substrate to thereby obtain a molding core (step 207); (h) providing a second substrate and a hot-press die, and hot compact pressing the second substrate using the molding core (step 208); and (i) removing the second substrate to thereby obtain the light guide plate (step 209).

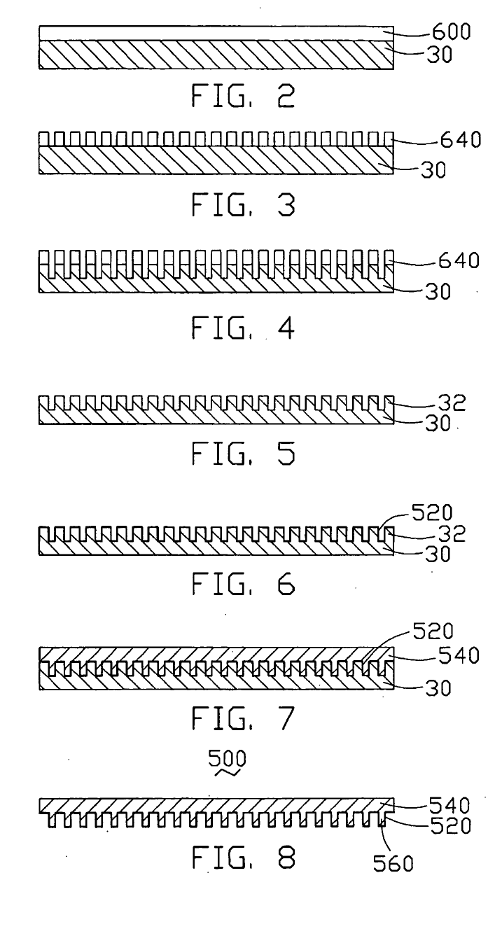

Referring to FIG. 2, a first substrate 30 is provided. The first substrate 30 is made of silicon. The first substrate 30 is baked in a vacuum or in a nitrogen environment at a temperature between 100° C. and 120° C. for 4˜6 minutes, in order to dehydrate the first substrate 30. After that, a light sensitive layer like a photo-resist layer 600 is coated on the first substrate 30 by a spin-coating method or a spray-coating method. The photo-resist layer 600 is an organic, negative photo-resist. Then, the first substrate 30 having the photo-resist layer 600 is baked at a temperature between 90° C. and 100° C. for 20˜30 minutes to enhance adhesion between the photo-resist layer 600 and the first substrate 30.

Referring to FIG. 3, the photo-resist layer 600 is exposed and developed. Ultraviolet (UV) radiation is emitted through a photo-mask (not shown) onto the photo-resist layer 600, the photo-mask having a predetermined pattern. Exposed parts of the photo-resist layer 600 receive the UV radiation. Subsequently, only unexposed parts of the photo-resist layer 600 are capable of being dissolved in a developer.

After exposure, a baking step is performed again. The first substrate 30 is baked at a temperature between 100° C. and 120° C. for 20˜30 minutes, in order to make the exposed parts of the photo-resist layer 600 further resistant to being dissolved.

Then a developer which can dissolve the unexposed parts of the photo-resist layer 600 is sprayed on the photo-resist layer 600. The first substrate 30 is maintained for 30˜60 seconds in order that the unexposed parts of the photo-resist layer 600 are fully dissolved. The exposed parts of the photo-resist layer 600 remain and cooperatively define a photo-resist pattern 640.

Referring to FIG. 4, the first substrate 30 is dry etched. The dry etching method is reactive ion etching. The substrate 30 is placed in a reaction chamber. A voltage in the range from 300˜500 V is applied to the chamber. Gas ions in the reaction chamber are driven by the voltage, and are accelerated to bombard the first substrate 30 having the photo-resist pattern 640. Parts of the first substrate 30 that are not covered by the photo-resist pattern 640 are etched to a predetermined depth. Thereby, the pattern of the photo-mask is transferred onto the first substrate 30 through the photo-resist pattern 640. A pressure of the reaction chamber is in the range from 10⁻¹˜10⁻³ torr. The gas ions are chloride ions, such as from carbon tetrachloride (CCl₄) or boron chloride (BCl₃).

Referring to FIG. 5, the photo-resist pattern 640 is removed. A chemical solution, which can only dissolve the photo-resist pattern 640, is sprayed onto the first substrate 30. The photo-resist pattern 640 is thus dissolved and removed.

Referring to FIG. 6, a thin metal film 520 is formed on the surface of the first substrate 30 having the pattern. The metal film 520 is made of nickel. The first substrate 30 is placed in a chamber of a sputtering machine (not shown), and the chamber is heated to a temperature of 150° C. at a pressure of 0.05 torr. A plasma reactive gas is introduced into the chamber. The metal film 520 having a thickness in the range from 20˜50 nanometers is thus formed on the first substrate 30 by deposition.

Referring to FIG. 7, a metal layer 540 having a thickness in the range from 0.4˜2 mm is electroformed on the metal film 520 of the first substrate 30. The metal layer 540 is made of nickel. The first substrate 30 is immersed into an electroforming solution. The electroforming solution includes a nickel-containing solution, a hypophosphite solution, and an accelerant. The nickel-containing solution can be a nickel sulfate solution. Alternatively, a nickel chloride solution can be used instead of the nickel sulfate solution. The accelerant is an alkali halide. Moreover, the electroforming solution also includes a pH regulator, a wetting agent and a lustering agent to enhance the quality of electroforming. A pH value of the electroforming solution is in the range from 4.2˜4.8, and can be regulated by the pH regulator.

Referring to FIG. 8, the first substrate 30 is removed to thereby obtain a molding core 500. The molding core 500 comprises the metal layer 540 and the metal film 520. The molding core 500 defines a molding pattern 560.

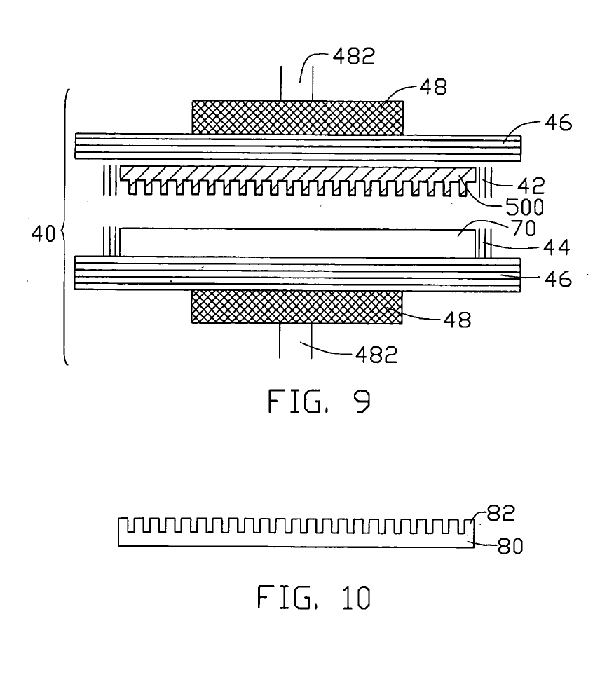

Referring to FIG. 9, a second substrate 70 is provided. The second substrate 70 is made of polymethyl methacrylate (PMMA).

A hot-press die 40 is provided. The hot-press die 40 includes a molding core receptacle 42, a substrate receptacle 44 opposite to the molding core receptacle 42, two heaters 46, and two cooling units 48. Each cooling unit 48 has a coolant channel 482.

The molding core 500 is placed in the molding core receptacle 42, and the second substrate 70 is placed in the substrate receptacle 44. The second substrate 70 is heated to a temperature in the range from 90˜95° C. Then, the molding core 500 is moved toward the second substrate 70 and presses the second substrate 70. The molding core pattern 560 is thus transferred onto the second substrate 70.

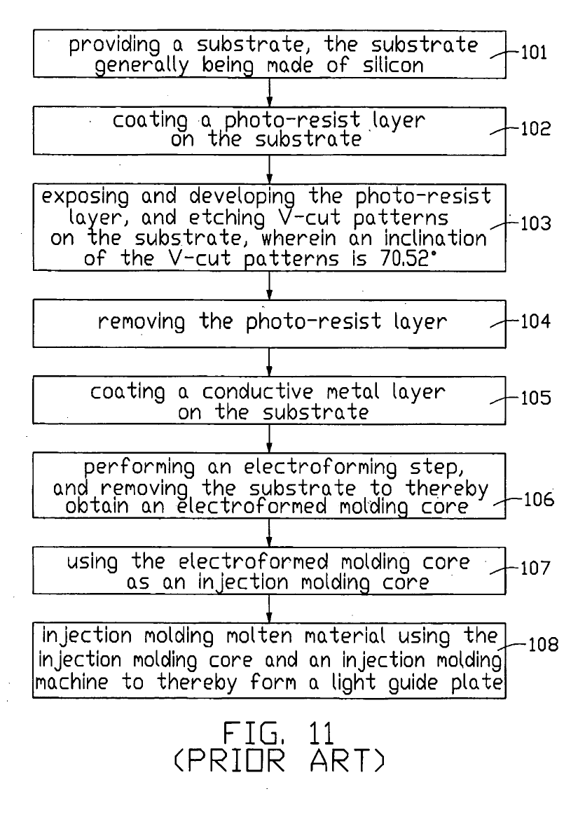

Referring to FIG. 10, the second substrate 70 is cooled, and is taken out from the hot-press die 40. A light guide plate 80 having an optical pattern 82 is thus obtained. The optical pattern 82 is same as the pattern of the photo-mask.

The present invention may have other embodiments as follows. The first substrate 30 can be made of glass. The photo-resist layer 600 can be an organic, positive photo-resist. If an organic, positive photo-resist is used, a developer that can dissolve a positive photo-resist is also used. In such case, the exposed parts of the photo-resist layer 600 are dissolved by the developer. The metal film 520 and the metal layer 540 can be made of a cobalt nickel alloy, copper, or a copper alloy. The dry etching method can be sputtering, ion beam etching, or plasma etching. Alternatively, a wet etching method can be used to etch the first substrate 30. The second substrate 70 can be made of polycarbonate (PC).

The main advantage of the present invention is as follows. The second substrate 70 is heated until it is plastic, so that it can be easily pressed to form a predetermined shape. During the whole process, the second substrate 70 is never in liquid form, so that the “reflux” problem of the prior art is effectively eliminated. In summary, it is easy to properly form the light guide plate 80 using the hot-pressing method of the present invention.

It is to be understood that even though numerous characteristics and advantages of the present invention have been set out in the foregoing description, together with details of the steps and associated structure and function of the invention, the disclosure is illustrative only, and changes may be made in detail, especially in matters of arrangement of steps within the principles of the invention to the full extent indicated by the broad general meaning of the terms in which the appended claims are expressed.

1. A method for fabricating a light guide plate, comprising:
(a) providing a first substrate, and coating a photo-resist layer thereon;
(b) exposing and developing the photo-resist layer using a photo-mask to thereby form a photo-resist pattern on the first substrate;
(c) etching the first substrate;
(d) removing the photo-resist pattern;
(e) coating a metal film on the first substrate;
(f) electroforming a metal layer on the metal film;
(g) removing the first substrate to thereby obtain a molding core;
(h) providing a second substrate, and hot-pressing the second substrate in a hot-press die using the molding core; and
(i) removing the second substrate to thereby obtain the light guide plate.

2. The method for fabricating a light guide plate as recited in claim 1, wherein the first substrate is made of silicon.

3. The method for fabricating a light guide plate as recited in claim 1, wherein the first substrate is made of glass.

4. The method for fabricating a light guide plate as recited in claim 1, wherein the photo-resist layer is an organic, negative photo-resist.

5. The method for fabricating a light guide plate as recited in claim 1, wherein the photo-resist layer is an organic, positive photo-resist.

6. The method for fabricating a light guide plate as recited in claim 1, wherein the photo-resist layer is spray-coated on first substrate.

7. The method for fabricating a light guide plate as recited in claim 1, wherein the photo-resist layer is spin-coated on the first substrate.

8. The method for fabricating a light guide plate as recited in claim 1, wherein in step (c), a dry etching method is used.

9. The method for fabricating a light guide plate as recited in claim 8, wherein in step (d), the dry etching method is reactive ion etching, sputtering, ion beam etching, or plasma etching.

10. The method for fabricating a light guide plate as recited in claim 1, wherein in step (d), a wet etching method is used.

11. The method for fabricating a light guide plate as recited in claim 1, wherein the metal film is made of nickel, a cobalt nickel alloy, copper, or a copper alloy.

12. The method for fabricating a light guide plate as recited in claim 1, wherein the metal layer is made of nickel, a cobalt nickel alloy, copper, or a copper alloy.

13. The method for fabricating a light guide plate as recited in claim 1, wherein second substrate is made of polymethyl methacrylate (PMMA).

14. The method for fabricating a light guide plate as recited in claim 1, wherein second substrate is made of polycarbonate (PC).

15. A method for fabricating a light guide member, comprising:
providing a substrate;
etching said substrate via a light-sensitive layer to form a predetermined pattern on said substrate;
electroforming a metal layer on said predetermined pattern of said substrate;
removing said substrate to turn said metal layer into a mold; and
using said mold to fabricate said light guide member via a hot pressing process.

16. A method for fabricating a member with a pattern surface, comprising:
providing a substrate;
etching said substrate to form said pattern surface on said substrate;
electroforming a mold layer on said pattern surface of said substrate;
removing said substrate to turn said mold layer into a mold; and
using said mold to fabricate said member via hot pressing said mold onto said member to form said pattern surface of said member.
